(19) United States
(12) Patent Application Publication
(10) Pub. No.: US 2007/0024694 A1
(43) Pub. Date: Feb. 1, 2007

(54) Thermal print head

(76) Inventors: Darwin M. Hanks, Fort Collins, CO (US); Greg J. Lipinski, Loveland, CO (US); Lawrence N. Taugher, Loveland, CO (US); Kevin L. Colburn, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,399

(22) Filed: Jul. 27, 2005

(51) Int. Cl. B41J 3/407

(52) U.S. Cl. 347/218; 101/43; 101/42

(57) ABSTRACT

Optically visible marks are disposed on a medium by exposing at least a portion of a coating disposed on the medium to thermal energy from a thermal print head in an optical disc drive.

### BACKGROUND

Labeling optical storage discs, such as (compact discs) CDs, (digital versatile discs) DVDs, and the like, may be accomplished in various ways. One method involves exposing a coating on a disc to light, such as laser light. Exposing the coating to light produces a chemical change in the coating that shows up as visible marks that form a portion of a label. However, this method can take a relatively long time to produce a label.

### DESCRIPTION OF THE DRAWINGS

FIG. 1 is a block diagram illustrating an embodiment of an optical disc drive system, according to an embodiment of the invention.

FIG. 2 is a view of an embodiment of a thermal print head taken along line 2-2 of FIG. 1, according to an embodiment of the invention.

FIG. 3 is a view of an embodiment of a thermal print head taken along line 3-3 of FIG. 1, according to another embodiment of the invention.

FIG. 4A illustrates an optical disc, according to an embodiment of the invention.

FIG. 4B illustrates an embodiment of a sensor configuration, according to another embodiment of the invention.

FIG. 4C illustrates exemplary outputs from the sensor configuration of FIG. 4B, according to another embodiment of the invention.

FIG. 4D illustrates an exemplary accumulated output constructed from the exemplary outputs of FIG. 4C, according to another embodiment of the invention.

FIGS. 5A and 5B illustrate an embodiment of operation of a disc drive, according to an embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

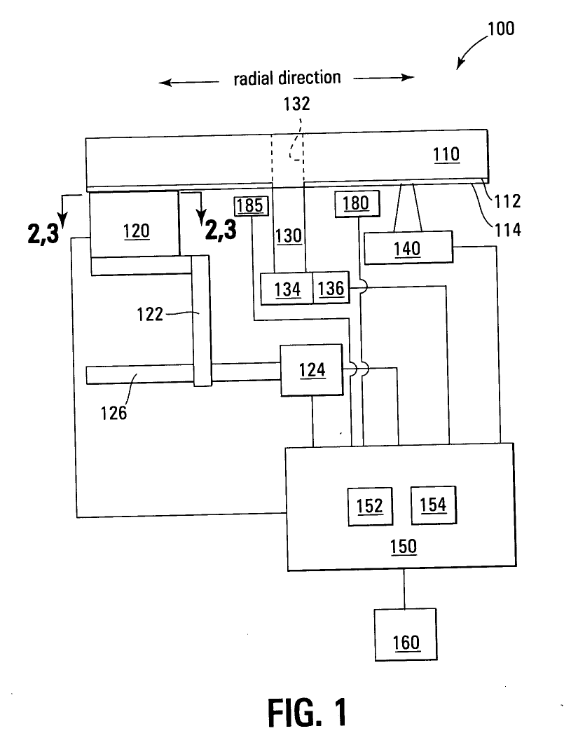

FIG. 1 is a block diagram illustrating an optical disc drive system 100 as a portion of a disc-media marking device, according to an embodiment. Optical disc drive system 100 can produce optically visible marks on a label side 112 of a rotatable medium, such as an optical disc 110, e.g., a compact disc (CD), a digital versatile disc (DVD), or the like by exposing a thermally-sensitive coating 114 disposed on, or fabricated as part of, label side 112 to thermal energy from a thermal print head 120. Coating 114 may include a dye. The disc media-marking device may be implemented as a stand-alone appliance device for labeling disc media, or as part of an optical media player or drive, such as a writable compact disc (CD), a digital versatile disc (DVD) player, or the like.

For one embodiment, a sled 122 carries thermal print head 120. In some embodiments, a drive mechanism 124 moves sled 120 radially on a rail 126. For one embodiment, drive mechanism 124 may include a coarse-adjust motor, such as a stepper motor, that provides a coarse adjustment of the sled 122 and a fine-adjust motor, such as a voice coil motor, that provides a fine adjustment the of sled 122. For another embodiment, a spindle 130 passes through a hole 132, passing through a center of optical disc 110. A spindle motor 134 rotates spindle 130 and thus optical disc 110. For another embodiment, a rotary encoder 136 is connected to spindle motor 134. For some embodiments, spindle motor 134, spindle 130, and rotary encoder 136 constitute a rotational drive mechanism for rotating optical disc 110.

For one embodiment, thermal print head 120 provides thermal energy that heats coating 114 past a critical temperature, thereby producing a chemical change that shows up as an optically visible mark on label side 112 that forms a portion of a label. That is, heating portions (or pixels) of the coating past the critical temperature causes these pixels to turn substantially a single shade of darkness. For another embodiment, various shades of gray may be obtained by using half-toning. For another embodiment, half-toning may include interspersing dark pixels, i.e., pixels exposed to heating, among light pixels, i.e., pixels not exposed to heating, where the percentage of dark to light pixels determines the darkness perceived by a viewer. For some embodiments, thermal print head 120 is kept in direct contact with coating 114, as shown in FIG. 1, as it heats coating 114, thus producing optically visible marks on a label side 112 as a result of direct contact heating. For other embodiments, a small gap (not shown) separates thermal print head 120 from coating 114 as the thermal energy heats coating 114. For these embodiments, thermal print head 120 supplies the thermal energy to coating 114 in the form of thermal radiation that is in turn absorbed by coating 114.

For some embodiments, an electromagnetic radiation source 140, such as an ultra-violet light source, e.g., a laser, LED, ultraviolet lamp, or the like, may be used to treat the optically visible marks formed on label side 112. This may be done to increase the life of the marks when using coatings having lower critical temperatures at which the marks form. Note, for example, that without the use of source 140 the life of the marks may be compromised for coatings having lower critical temperatures when the disc is stored in higher temperature environments, such as in automobiles during the summer. For some embodiments, electromagnetic radiation source 140 may expose an entire label at once or may expose the label marks on a track-by-track basis, e.g., by moving electromagnetic radiation source 140 radially using a sled/rail system similar to that for moving thermal print head 120.

A controller 150 controls thermal print head 120, spindle motor 134, encoder 136, drive mechanism 124, and electromagnetic radiation source 140. For another embodiment, controller 150 is coupled to a host 160, such as a main controller of a disc-media marking device, a computer that includes optical disc drive system 100, or the like.

For one embodiment, controller 150 includes a processor 152 for processing computer/processor-readable instructions. These computer-readable instructions are stored on a computer-usable media 154 and may be in the form of software, firmware, or hardware. As a whole, these computer-readable instructions are often termed a device driver. In a hardware solution, the instructions are hard coded as part of a processor, e.g., an application-specific integrated circuit (ASIC) chip. In a software or firmware solution, the instructions are stored for retrieval by the processor 152. Some additional examples of computer-usable media include static or dynamic random access memory (SRAM or DRAM), read-only memory (ROM), electrically-erasable programmable ROM (EEPROM or flash memory), magnetic media and optical media, whether permanent or removable.

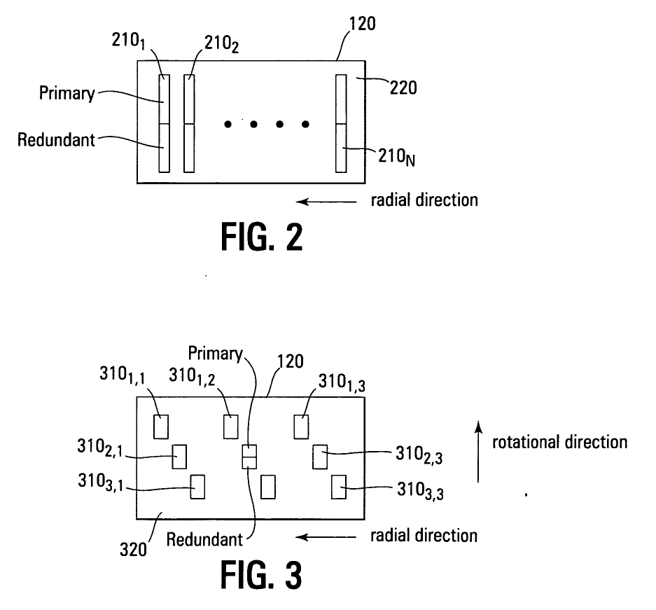

FIG. 2 is a view of thermal print head 120 taken along line 2-2 of FIG. 1, according to an embodiment. Thermal print head 120 includes a plurality of heating elements 210, e.g., resistors, formed on a face 220 that contacts coating 114 or faces label side 112 of optical disc 110. For one embodiment, heating elements are selectively activated in response to signals from controller 150.

FIG. 3 is a view of thermal print head 120 taken along line 3-3 of FIG. 1, according to another embodiment. The example of FIG. 3 shows an array of heating elements 310 disposed on face 320 arranged in rows, in the rotational direction of disc 110, and columns, in the radial direction. Note that successive heating elements of a column are misaligned with each other in the radial direction, e.g., heating element 310_{1,1} is misaligned with heating element 310_{2,1} and heating element 310_{2,1} is misaligned with heating element 310_{3,1}. Moreover, the successive heating elements 310 of each column respectively correspond to successive radial locations (or tracks) on disc 110, e.g., heating element 310_{1,1} may correspond to track 1, heating element 310_{2,1} track 2, heating element 310_{3,1} track 3, heating element 310_{1,2} track 4, etc. Misaligning the heating elements of each row in the radial direction enables a smaller radial spacing between radial locations on disc 110.

For one embodiment, heating elements 210 or heating elements 310 may each comprise two heating elements, a primary heating element and a redundant heating element that would replace the corresponding primary heating element if that primary heating element becomes defective. For one embodiment, the elements in substantially the same location such that the difference in position will not be perceived by a user examining a marked disc. Alternatively the writing time advanced or delayed so as to use the rotation to compensate for the difference in position. For one embodiment, the resistance of the primary heating elements is monitored. For another embodiment, if the monitored resistance of a primary heating element exceeds a predetermined resistance indicative of an open or otherwise defective primary heating element, the corresponding redundant heating element would be activated, and the activation of that redundant heating element would be synchronized accordingly. In other embodiments, instead of using redundant heating elements upon detecting a defective heating element, one of the remaining heating elements may be activated and positioned, using thermal print head 120, to replace the defective heating element in addition to performing its originally intended functions.

For some embodiments, the heating elements may be coated, e.g., using TEFLON or the like, so as not to damage, e.g., mar or scratch, disc 110. For other embodiments, thermal print head 120 may be fabricated from or coated with a material, such as TEFLON, that will not damage disc 110.

For one embodiment, thermal print head 120 is sized to produce a suitable printing resolution, e.g., about 600 dots per inch that corresponds to a pixel size of about 40 microns in diameter. An exemplary size of thermal print head 120 for producing pixels of about 40 microns in diameter would include heating elements on the order of 25 percent smaller in diameter than a target pixel size, e.g., to provide a margin for spreading of the pixel as heat spreads during the marking process.

For some embodiments, the heating elements or thermal print head have a relatively high thermal diffusivity so that a temperature of a heater element or the print head can be heated to a predetermined temperature sufficient to heat the coating above the critical temperature for producing a mark or cooled to a predetermined temperature below the temperature sufficient to heat the coating above the critical temperature for producing a mark within a fraction of a time it takes to form a mark. For another embodiment, the heating elements or thermal print head may be preheated to a temperature that is just below a predetermined temperature sufficient to heat the coating above the critical temperature for producing a mark. For another embodiment, the predetermined temperature may be determined through computer and/or experimental simulations for various operating conditions, e.g., operating temperatures of disc 110, etc.

For some embodiments, thermal print head 120 is adapted so that when thermal print head is in contact with disc 110 the same contact pressure is applied to each of the heating elements, e.g., heating elements 210 or 310. For one embodiment, spring loading of each of the heating elements in the print head 120 accomplishes this.

In some embodiments, the marks may be fully formed in a single pass or revolution of disc 110. Note that a certain amount of heat energy is required at a desired mark location (or pixel) to raise the temperature at this location past the critical temperature to form a mark. Note further that amount of heat energy delivered to a location depends at least in part on the heat output of the heater elements and the time the heater elements are adjacent the desired mark location, which depends on the rotation speed. Therefore, for other embodiments, the same locations on label side 112 of disc 110 are cumulatively heated on each of several revolutions of disc 110 by energizing the heater elements for each revolution of the disc. The cumulative heat imparted to each location produces a mark at that location when the amount of cumulative heat energy transferred to the location is sufficient to bring the temperature past the critical temperature. This process enables higher rotational speeds of disc 110 for a fixed heat output of the heating elements. Note that as the rotational speed increases, the amount of time each location is adjacent a heating element decreases, thus reducing the amount of thermal energy that is transferred to that location for a fixed heat output of the heating element.

When using thermal print head to produce marks at several radial locations on label side 112 of disc 110, such as the entire labelable portion, substantially simultaneously, the tangential velocity is different at each radial location. That is, the tangential velocity increases with the radius. Therefore, for some embodiments, the power applied to the heating elements is increased as the radial location corresponding to the heating elements increases and thus the rate of thermal energy transferred to the different radial locations increases with the radius so that the amount of thermal energy transferred to the different radial locations is substantially the same. Otherwise, if the same power were applied to each heating element, more thermal energy would be transferred to the locations at the lower radii than the higher radii because of the longer times at the lower radii because of the lower tangential velocities. This could result in darker marks at the lower radii.

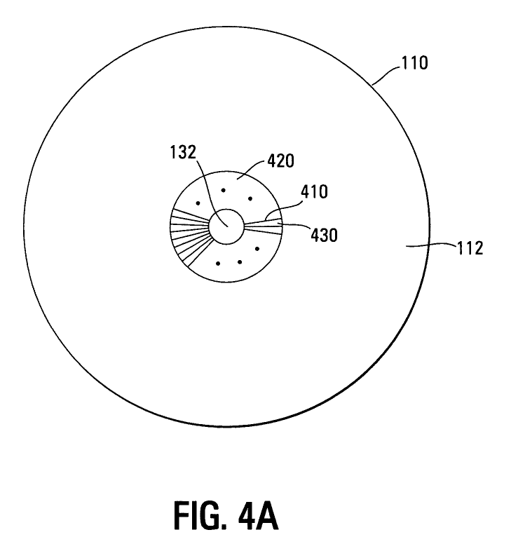

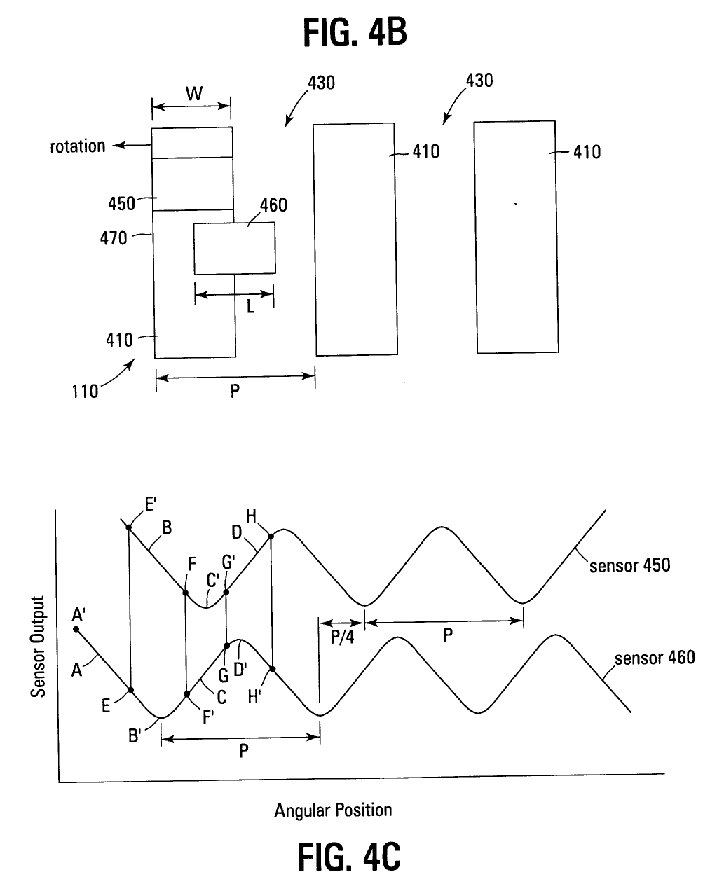

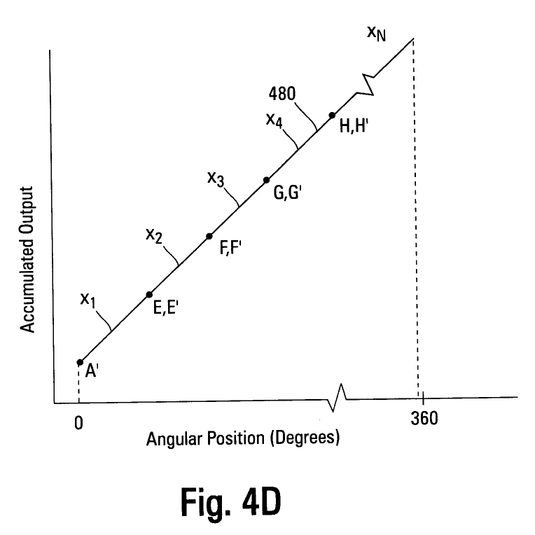

For one embodiment, synchronizing the energization of the heating elements to the rotation of the disc may be accomplished by generating a write clock, e.g., using a phase locked loop. For example, one clock edge of the write clock, e.g., positive clock edge, may be used to activate a heating element when that heating element is adjacent a pixel to be written, and another clock edge, e.g., a negative, or another positive, clock edge to deactivate the heating element after writing the pixel. Alternatively, an open loop method may be employed. One example of an open-loop method involves accurately controlling the rotational speed of the disc and then triggering the energization of the heating elements based upon a timing signal associated with the disc rotation. For one embodiment, triggering may be accomplished by sensing timing marks (or spokes), such as spoke 410, located within a control feature region 420 on (or visible from) label side 112 of disc 110, as shown in FIG. 4A, using a sensor 180 connected to controller 150, as shown in FIG. 1. Spokes 410 are typically used for timing disc 110 for maintaining disc 110 at a predetermined rotational speed. For one embodiment, spokes 410 have a lower reflectivity than inter-spoke regions 430.

For some embodiments, encoder 136 (FIG. 1) has optical sensors 450 and 460, as shown in FIG. 4B, according to an embodiment. For other embodiments, a light source 185, e.g., a light emitting diode, as shown in FIG. 1, is directed at the control feature region 420, illustrated in FIG. 4A, and sensors 450 and 460 sense light reflected off the spokes 410 and inter-spoke regions 430. For one embodiment, sensors 450 and 460 have a length L that is substantially the same as the width W of a spoke 410, as shown in FIG. 4B. That is, when one of the sensors, e.g., sensor 450, is centered over a spoke 410, it spans the entire width Wof that spoke. FIG. 4B also shows that spokes 410 have pitch P, i.e., defined as a distance between the leading edges 470 of successive spokes 410, as disc 110 is rotating in the direction shown. For another embodiment, sensors 450 and 460 are spaced so their center-to-center spacing is ¼ of the pitch P. That is, sensor 460 leads sensor 450 relative to the rotation of disc 110.

For one embodiment, sensors 450 and 460 produce an analog output. FIG. 4C illustrates an exemplary output of sensors 450 and 460 versus the angular position of disc 110 relative to sensors 450 and 460 as disc 110 rotates. Note that the outputs of sensors 450 and 460 are substantially periodic with a period substantially equal to the pitch P. Also note that the output of sensor 460 leads the output of sensor 450 by substantially ¼ of the period (or pitch P). When one of the sensors, e.g., sensor 450, is located directly over (or aligned with) a spoke 410, its output is a minimum, whereas when one of the sensors is directly over (or aligned with) an inter-spoke region 430, its output is a maximum. This is because inter-spoke regions 430 have a greater reflectivity than spokes 410. Moreover, the output of each of sensors 450 and 460 is substantially linear with position between successive maxima and minima, with the output becoming substantially non-linear adjacent the maxima and minima.

Note that the center-to-center spacing of ¼ of the pitch P between sensors 450 and 460 enables a portion of a linear portion of the output of one of the sensors to correspond to a non-linear portion of the other sensor. For example, a portion B of a linear portion of the output of sensor 450 of FIG. 4C corresponds to a non-linear portion B′ of the output of sensor 460, a portion C of a linear portion of the output of sensor 460 corresponds to a non-linear portion C′ of the output of sensor 450, a portion D of a linear portion of the output of sensor 450 corresponds to a non-linear portion D′ of the output of sensor 460, etc. This enables the construction of a modified (or an accumulated) signal, such as signal 480 of FIG. 4D, that increases with angular position for each revolution of disc 110 and that has a single output value for each angular position of the revolution.

Signal 480 is constructed as follows for one embodiment: The absolute value (or magnitude) of the slope is obtained for each linear portion between a maxima and minima of the outputs of sensors 450 and 460, e.g., of the slopes of linear portions A, B, C, D, etc. of FIG. 4C. Point A′ (FIGS. 4C and 4D) is selected to be a reference location, e.g., zero (0) degrees, and the output of sensor 460 at point A′ selected to be the output thereat. The value of signal 480 is increased from point A′ at a rate of the magnitude of the slope of linear portion A of the output of sensor 460 to produce a portion xᵢ of signal 480. Before the output of sensor 460 becomes non-linear (portion B′ of FIG. 4C), e.g., at point E of the output of sensor 460, the output of sensor 450 is selected, starting at the same angular position, e.g., point E′ of the output of sensor 450, where sensor 460 was stopped being used. Graphically, this corresponds to moving from point E to point E′ along a line of constant angular position in FIG. 4C. The output of sensor 450 at point E′ is then adjusted to equal the output of sensor 460 at point E to establish the common point E, E′ of signal 480. The value of signal 480 is then increased at the rate of the magnitude of the slope of linear portion B of the output of sensor 450 to produce a portion x₂ of signal 480. Before the output of sensor 450 becomes non-linear (portion C of FIG. 4C), e.g., at point F of the output of sensor 450, the output of sensor 460 is used e.g., point F′ of the output of sensor 460, starting at the same angular position where sensor 450 was stopped being used.

The above procedure is repeated to produce portion X₃ of signal 480 between common points F, F′ and G, G′, portion x₄ between common points G, G′ and H, H′ of FIG. 4D through portion X_{N} that extends to an angular location just below 360 degrees. After one revolution of disc 110, e.g., at an angular position of 360 degrees, which is the same as zero degrees, signal 480 is repeated.

To control the rotational speed of disc 110, the actual angular distance moved by disc 110 during a predetermined time period, initiated at zero degrees, for example, is determined as described above from the accumulated output of sensors 450 and 460. Dividing the actual distance by the time period gives the actual rotational speed that is compared to, e.g., subtracted from, the desired rotational speed. The rotational speed will be adjusted based on the difference between the desired and actual rotational speeds. The process may be repeated until the difference is at a predetermined value, e.g., substantially zero.

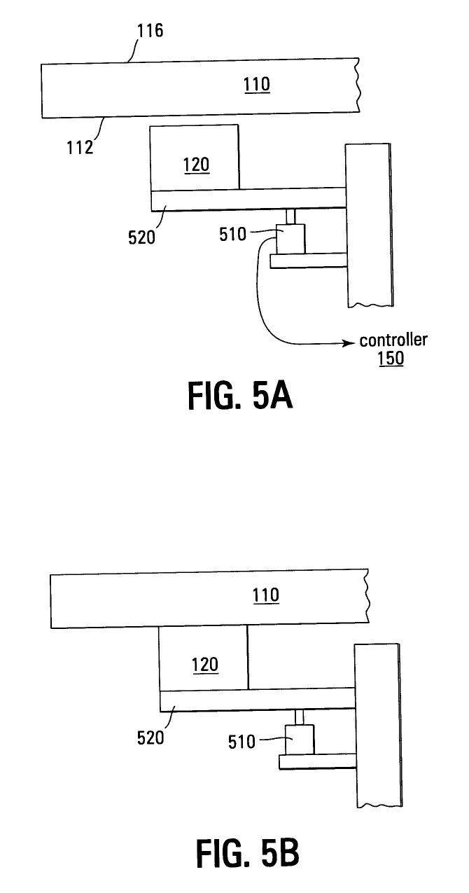

For one embodiment, thermal print head 120 may be moved out of contact with label side 112 of disc 110, as shown in FIG. 5A, when data is being written on a side 116 of disc 110 that is opposite of label side 112 or when data is being read from side 116 during a playback mode. Then, to write a label on label side 112, thermal print head 120 is brought contact with label side 112, as shown in FIG. 5B. For another embodiment, an actuator 510, such as a solenoid, connected to a resilient (or spring-loaded) arm 520 may move thermal print head 120 into and out of contact with label side 112, as shown in FIGS. 5A and 5B. For another embodiment, thermal print head 120 may be connected to an arm connected to a rotatable shaft for rotating thermal print head 120 into and out of contact with label side 112.

### CONCLUSION

Although specific embodiments have been illustrated and described herein it is manifestly intended that the scope of the claimed subject matter be limited only by the following claims and equivalents thereof.

What is claimed is:

1. A method of producing a label on a rotating medium, comprising:
disposing optically visible marks on the rotating medium by exposing at least a portion of a coating disposed on the rotating medium to thermal energy from a thermal print head in an optical disc drive.

2. The method of claim 1, wherein exposing at least a portion of the coating comprises exposing that portion once per revolution of the medium for a plurality of revolutions.

3. The method of claim 1, wherein exposing at least a portion of the coating comprises exposing that portion during only a single revolution.

4. The method of claim 1, wherein the thermal print head is in direct contact with the medium during the disposing.

5. The method of claim 1, wherein the thermal print head is displaced from the medium by a gap during the disposing.

6. The method of claim 1, wherein exposing at least a portion of a coating disposed on the medium to thermal energy comprises exposing a plurality of different locations on the medium substantially simultaneously.

7. The method of claim 6, wherein exposing a plurality of different locations on the medium substantially simultaneously comprises exposing each of different radial locations to different rates of thermal energy transfer.

8. The method of claim 1, wherein the thermal print head comprises one or more heating elements.

9. The method of claim 1 further comprises treating the optically visible marks with electromagnetic radiation after the disposing.

10. The method of claim 9, wherein the electromagnetic radiation is ultra-violet electromagnetic radiation.

11. The method of claim 6, wherein exposing a plurality of different radial locations on the rotating medium substantially simultaneously comprises increasing the rate of thermal energy transfer as the radius of the radial locations increases.

12. The method of claim 1 further comprises synchronizing energization of the thermal print head to the rotation of the rotating medium.

13. The method of claim 12, wherein synchronizing the energization of the thermal print head to the rotation of the disc comprises generating a write clock that times the energization of the thermal print head.

14. The method of claim 12, wherein synchronizing the energization of the thermal print head to the rotation of the disc comprises triggering the energization of the thermal print head from a timing signal generated by sensing spokes on the rotating medium.

15. The method of claim 1 further comprises controlling the rotation of the rotating medium, wherein controlling the rotation of the rotating medium comprises:
sensing spokes on the rotating medium;
determining an actual rotational speed of the rotating medium in response to sensing the spokes;
comparing the actual rotational speed to a desired rotational speed; and
adjusting the rotational speed according to a difference between the desired rotational speed and the actual rotational speed.

16. The method of claim 1 further comprises heating the thermal print head to a first predetermined temperature sufficient to heat the coating above a critical temperature sufficient to produce the optically visible marks within a fraction of a time it takes to form one of the marks, or cooling the thermal print head to a second predetermined temperature below the first predetermined temperature within a fraction of the time it takes to form one of the marks, or both.

17. The method of claim 1 further comprises preheating the thermal print head to a temperature that is just below a critical temperature sufficient to produce the marks.

18. The method of claim 1 further comprises activating a redundant heating element of the thermal print head if a corresponding primary heating element of the thermal print head becomes defective.

19. A method of controlling a rotation a rotating medium rotating in an optical disc drive, comprising:
sensing spokes on the rotating medium; generating first and second signals that are out of phase by approximately ¼ of a pitch between successive spokes in response to sensing the spokes;
determining an actual rotational speed of the rotating medium by combining the first and second signals;
comparing the actual rotational speed to a desired rotational speed; and
adjusting the rotational speed according to a difference between the desired rotational speed and the actual rotational speed.

20. The method of claim 19, wherein combining the first and second signals forms a third signal that is substantially a linear function of an angular location on the rotating medium.

21. A computer-usable medium containing computer-readable instructions for causing an optical disc drive to perform a method comprising:
disposing optically visible marks on a rotating medium by exposing at least a portion of a coating disposed on the rotating medium to thermal energy from a thermal print head in the optical disc drive.

22. The computer-usable medium of claim 21, wherein, in the method, exposing at least a portion of the coating comprises exposing that portion once per revolution of the medium for a plurality of revolutions.

23. The computer-usable medium of claim 21, wherein, in the method, exposing at least a portion of a coating disposed on the medium to thermal energy comprises exposing a plurality of different locations on the medium substantially simultaneously.

24. The computer-usable medium of claim 23, wherein, in the method, exposing a plurality of different locations on the medium substantially simultaneously comprises exposing each of different radial locations to different rates of thermal energy transfer.

25. The computer-usable medium of claim 21, wherein the method further comprises treating the optically visible marks with electromagnetic radiation.

26. An optical disc drive, comprising:
means for rotating an optical disc; and
means for disposing optically visible marks on the optical disc by exposing at least a portion of a coating disposed on the optical disc to thermal energy from a thermal print head when the optical disc is rotating.

27. The optical disc drive of claim 26 further comprises means for generating a write clock that synchronizes energization of the thermal print head to the rotation of the thermal print head.

28. The optical disc drive of claim 26 further comprises means for triggering energization of the thermal print head from a timing signal generated by sensing spokes on the optical disc.

29. The optical disc drive of claim 26 further comprises means for controlling the rotation of the optical disc, wherein the rotation controlling means comprises:
means for sensing spokes on the optical disc;
means for determining an actual rotational speed of the rotating medium in response to sensing the spokes;
means for comparing the actual rotational speed to a desired rotational speed; and
means for adjusting the rotational speed according to a difference between the desired rotational speed and the actual rotational speed.

30. An optical disc drive, comprising:
a rotational drive mechanism configured to rotate an optical disc; and
a thermal print head configured to dispose optically visible marks on the optical disc by exposing at least a portion of a coating disposed on the optical disc to thermal energy from the thermal print head when the optical disc is rotating.

31. The optical disc drive of claim 30, wherein the thermal print head comprises one or more heating elements.

32. The optical disc drive of claim 31, wherein each of the heating elements is a resistive heating element.

33. The optical disc drive of claim 31, wherein the thermal print head is configured so that when the thermal print head is in contact with the optical disc, the same contact pressure is applied to each of the heating elements.

34. The optical disc drive of claim 30, wherein the thermal print head comprises an array of heating elements arranged in rows in a rotational direction of the disc and columns in a radial direction.

35. The optical disc drive of claim 34, wherein successive heating elements of a column are misaligned with each other in the radial direction.

36. The optical disc drive of claim 30 further comprises an electromagnetic radiation source for treating the optically visible marks.

37. The optical disc drive of claim 30 further comprises an actuator connected to the thermal print head for selectively moving the thermal print head in and out of contact with the optical disc.

38. The optical disc drive of claim 30, wherein the thermal print head comprises one or more primary heating elements and one or more redundant heating elements respectively corresponding to the one or more primary heating elements.

39. The optical disc drive of claim 30, wherein the thermal print head comprises a material that will not damage the optical disc.
